(19) United States
(12) Patent Application Publication
(10) Pub. No.: US 2004/0034182 A1
(43) Pub. Date: Feb. 19, 2004

(54) Method for the production of a polymerisation reaction product

(76) Inventors: Roman Benedikt Raether, Limburgerhof (DE); Susanne Brinkmann-Rengel, Ober-Olm (DE); Sylke Haremza, Neckargemund (DE); Wolfgang Bremser, Muenster (DE)

Correspondence Address: KEIL & WEINKAUF, 1350 CONNECTICUT AVENUE, N.W., WASHINGTON, DC, 20036, US

(21) Appl. No.: 10/297,207

(22) PCT Filed: Jun. 13, 2001
(86) PCT No.: PCT/EP01/06714

(30) Foreign Application Priority Data
Jun. 16, 2000 (DE) 100 29 695.5

(51) Int. Cl. C08F 30/02

(52) U.S. Cl. 526/274; 526/310; 526/335

(57) ABSTRACT

A process for the preparation of a reaction product (A) comprises the following stage (i):

(i) Reaction, under free radical conditions, of a reaction mixture comprising at least one monomer (a), capable of free radical reaction, in the presence of at least one compound of the formula (I)

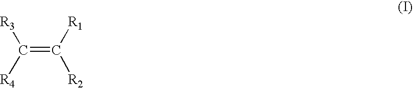

where R₁ to R₄, independently of one another, are each hydrogen, methyl or a group which stabilizes radicals and/or is bulky and which is selected from an unsubstituted or substituted, linear or branched alkyl of two or more carbon atoms, a cycloalkyl, alcohol, ether, polyether, amine or aralkyl radical, a substituted or unsubstituted aromatic, heterocyclic or olefinic hydrocarbon, a halogen atom, a substituted or unsubstituted, linear or branched alkenyl or alkynyl group, —C(O)R₅, —C(O)OR₅, —CR₅R₆—O—R₇, —O—C(O)R₅, —CN, —O—CN, —S—CN, —O—C═NR₅, —S—C═NR₅, —O—CR₅R₆—CR₇R₈NR₉R₁₀, —N═C═O, —C═NR₅, —CR₅R₆-Hal, —C(S)R₅, —CR₅R₆—P(O)R₇R₈, —CR₅R₆—PR₇R₈, —CR₅R₆—NR₇R₈, —CR₅R₆(OR₇)(OR₈), —CR₅R₆(OR₇)(NR₈), —CR₅R₆(NR₇)(NR₈), an anhydride, acetal or ketal group, —SO₂R₅, an amidine group, —NR₅C(S)NR₆, —NR₅C(S)—OR₆, —N═C═S, —NO₂, —C═N—OH, —N(R₅)═NR₆, —PR₅R₆R₇, —OSiR₅R₆R₇ or —SiR₅R₆R₇, where R₅ to R₁₀, independently of one another, are each defined in the same way as R₁ to R₄, or two of the radicals R₁ to R₄ form a C₄- to C₇-ring which in turn may be substituted or unsubstituted and may contain one or more heteroatoms,

with the proviso that

at least two of the radicals R₁ to R₄ are a group which stabilizes radicals and/or is bulky, as defined above, and diphenylethylene, dinaphthylethylene, 4,4′-vinylidenebis(N,N′-dimethylaniline), 4,4′-vinylidenebis(aminobenzene), cis- and trans-stilbene and mixtures of two or more thereof are excluded as compounds of the formula (I), and

a process for the preparation of a reaction product (A′) comprises the following stage (i):

(i) Reaction, under free radical conditions, of a reaction mixture comprising at least one monomer (a), capable of free radical reaction, in the presence of at least one compound of the formula (II)

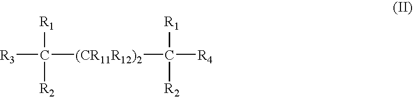

where R₁ to R₄ and R₁₁ and R₁₂, independently of one another, are each hydrogen, methyl or a group which stabilizes radicals and/or is bulky and which is selected from an unsubstituted or substituted, linear or branched alkyl of two or more carbon atoms, a cycloalkyl, alcohol, ether, polyether, amine or aralkyl radical, a substituted or unsubstituted aromatic, heterocyclic or olefinic hydrocarbon, a halogen atom, a substituted or unsubstituted, linear or branched alkenyl or alkynyl group, —C(O)R₅, —C(O)OR₅, —CR₅R₆—O—R₇, —O—C(O)R₅, —CN, —O—CN, —S—CN, —O—C═NR₅, —S—C═NR₅, —O—CR₅R₆—CR₇R₈NR₉R₁₀, —N═C═O, —C═NR₅, —CR₅R₆-Hal, —C(S)R₅, —CR₅R₆—P(O)R₇R₈, —CR₅R₆—PR₇R₈, —CR₅R₆—NR₇R₈, —CR₅R₆(OR₇)(OR₈), —CR₅R₆(OR₇)(NR₈), —CR₅R₆(NR₇)(NR₈), an anhydride, acetal or ketal group, —SO₂R₅, an amidine group, —NR₅C(S)NR₆, —NR₅C(S)—OR₆, —N═C═S, —NO₂, —C═N—OH, —N(R₅)═NR₆, —PR₅R₆R₇, —OSiR₅R₆R₇ or —SiR₅R₆R₇, where R₅ to R₁₀, independently of one another, are each defined in the same way as R₁ to R₄, or two of the radicals R₁ to R₄ form a C₄- to C₇-ring which in turn may be substituted or unsubstituted and may contain one or more heteroatoms,

with the proviso that

at least two of the radicals R₁ to R₄ are a group which stabilizes radicals and/or is bulky, as defined above.

The present invention relates to a process for the preparation of a reaction product (A) by reaction, under free radical conditions, of at least one monomer (a), capable of free radical reaction, in the presence of at least one free radical initiator and a compound (I) and/or a compound (II), as defined below, of this reaction product per se, a process for the preparation of a polymer using this reaction product, and its use in polymer dispersions or for the production of films, moldings, fibers and foams.

The present invention relates to the technical field of free radical polymerization. By an appropriate choice of monomers and, if required, successive addition of different monomers, both straight-chain and branched homopolymers and copolymers as well as block copolymers can be prepared. In addition to the polymers per se, the present invention also relates to a reaction product obtained in a first stage.

There has for some years been considerable interest in processes or process concepts which are suitable for the preparation of a multiplicity of polymers and make it possible to provide such polymers having a predetermined structure, molecular weight and molecular weight distribution. Thus, WO 98/01478 describes a process for the preparation of polymers, in which the monomer to be reacted, which in particular is selected from vinyl monomers and acid derivatives having unsaturated groups, e.g. anhydrides, esters and imides of (meth)acrylic acid, is reacted in the presence of a free radical initiator and of a thiocarbonylthio compound as a chain-transfer agent.

WO 92/13903 describes a process for the preparation of polymers having a low molecular weight by free radical chain polymerization of one or more polymers in the presence of a group-transfer agent as defined therein, which has the C—S double bond. According to this publication, the compounds described there and having a C—S double bond act not only as chain-transfer agents but also as growth regulators, so that, according to this publication, it is only possible to prepare polymers having a low molecular weight in the presence of this compound.

A process for the free radical chain polymerization of unsaturated monomers in an aqueous medium and in the presence of a macromonomer having a terminal —CH₂—C(X)═CH₂ group in which X is as defined therein is described in WO 93/22351. According to the examples of this application, different (meth)acrylates or (meth)acrylic acid or, if desired, monomers such as styrene are reacted there in each case under emulsion or suspension polymerization conditions.

WO 93/22355 relates to a process for the preparation of crosslinkable polymers using a macromonomer as described in WO 93/22351. WO 96/15157 likewise describes a process for the preparation of polymers having a comparatively narrow molecular weight distribution, in which a vinyl monomer defined therein is reacted with a macromonomer, likewise vinyl-terminated, in the presence of a free radical initiator. Furthermore, WO 98/37104 relates to the preparation of polymers controlled with respect to the molecular weight, including those based on acrylate, by free radical polymerization of corresponding monomers using a chain-transfer agent defined in more detail therein and having a C—C double bond and radicals which activate this double bond with respect to the free radical addition of monomers.

A free radical chain polymerization or copolymerization with an ω-unsaturated oligo(methyl methacrylate) using ethyl acrylate, styrene, methyl methacrylate, acrylonitrile and vinyl acetate as comonomers is described in a scientific article in J. Macromol. Sci. Chem. A 23 (7) (1986), 839-852.

Furthermore, Macromol. Chem. Phys. 201 (2000), 74-83 describes free radical chain polymerizations or copolymerizations using 1,2-(trimethylsilyloxy)-tetraphenylethane, where methyl methacrylate, styrene, phenyl acetate, butyl acrylate and glycidyl methacrylate are used as monomers.

An overview of free radical chain polymerizations using in particular tetraphenylethane (derivatives) is given by Otsu and Matsumoto in Advances in Polymer Science 136, 75-137, and in Polymer Bulletin 16 (1986), 95-102.

Furthermore, Harwood et al., in Macromol. Symp. 111 (1996), 25-35 report on NMR investigations into random, block and graft copolymers using NMR-sensitive initiators and macroinitiators. Inter alia, the reaction of a methyl methacrylate/stilbene mixture and the properties of the polymer resulting therefrom are described there.

A process for the preparation of a polymeric reaction product using in particular diphenylethylene and its derivatives is described in DE 19858708.2.

In view of this prior art, it is an object of the present invention to provide a novel process for the preparation of a reaction product which can also be used, inter alia, as a macroinitiator and which, on the one hand, can itself be used, inter alia, as an emulsifier or dispersant and with the aid of which further monomers capable of free radical polymerization or copolymerization can also be reacted in order to obtain further polymers which may have different compositions. It is a further object of the present invention to enable properties of polymers to be established in a controlled manner and hence to permit a wide range of potential uses of such polymers which are obtainable by simple free radical polymerization, in particular by preparation of block structures by means of free radical polymerization.

In the context of the present invention, “different monomer composition” is understood as meaning that at least two regions of the block copolymers have different monomer compositions. In the context of the present invention, it is possible that the transition between two blocks is continuous, i.e. there exists between two blocks a zone which has a random or regular sequence of the monomers constituting the blocks. In the context of the present invention, however, it is also envisaged that the transition between two blocks is essentially discontinuous. An “essentially discontinuous transition” is understood as meaning a transition zone which has a substantially shorter length than at least one of the blocks separated by the transition zone. It is possible that a block is based only on one type of monomer. However, it is also envisaged that a block is composed of two or more monomers. In a preferred embodiment of the present invention, the chain length of such a transition zone is less than 1/10, preferably less than 1/20, of the block length of at least one of the blocks separated by the transition zone.

In the context of the present invention, “different monomer composition” is understood as meaning that the monomers constituting the respective block differ in at least one feature, for example in their linkage to one another, in their conformation or in their constitution. If, as already described above, a block is based on more than one type of monomer, in the present context different blocks of the block copolymer may differ, for example, also through different concentrations of the monomers constituting each block.

We have found that this and further objects are achieved by the novel process for the preparation of a reaction product (A), which comprises the following stage (i):

(i) Reaction, under free radical conditions, of a reaction mixture comprising at least one monomer (a), capable of free radical reaction, in the presence of at least one compound of the formula (I)

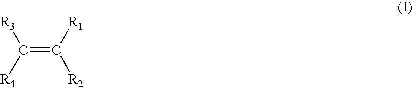

where R₁ to R₄, independently of one another, are each hydrogen, methyl or a group which stabilizes radicals and/or is bulky and which is selected from an unsubstituted or substituted, linear or branched alkyl of two or more carbon atoms, a cycloalkyl, alcohol, ether, polyether, amine or aralkyl radical, a substituted or unsubstituted aromatic, heterocyclic or olefinic hydrocarbon, a halogen atom, a substituted or unsubstituted, linear or branched alkenyl or alkynyl group, —C(O)R₅, —C(O)OR₅, —CR₅R₆—O—R₇, —O—C(O)R₅, —CN, —O—CN, —S—CN, —O—C═NR₅, —S—C═NR₅, —O—CR₅R₆—CR₇R₈NR₉R₁₀, —N═C═O, —C═NR₅, —CR₅R₆-Hal, —C(S)R₅, —CR₅R₆—P(O)R₇R₈, —CR₅R₆—PR₇R₈, —CR₅R₆—NR₇R₈, —CR₅R₆(OR₇)(OR₈), —CR₅R₆(OR₇)(NR₈), —CR₅R₆(NR₇)(NR₈), an anhydride, acetal or ketal group, —SO₂R₅, an amidine group, —NR₅C(S)NR₆, —NR₅C(S)—OR₆, —N═C═S, —NO₂, —C═N—OH, —N(R₅)═NR₆, —PR₅R₆R₇, —OSiR₅R₆R₇ or —SiR₅R₆R₇, where R₅ to R₁₀, independently of one another, are each defined in the same way as R₁ to R₄, or two of the radicals R₁ to R₄ form a C₄- to C₇-ring which in turn may be substituted or unsubstituted and may contain one or more heteroatoms,

with the proviso that

at least two of the radicals R₁ to R₄ are a group which stabilizes radicals and/or is bulky, as defined above, and diphenylethylene, dinaphthylethylene, 4,4′-vinylidenebis(N,N′-dimethylaniline), 4,4′-vinylidenebis(aminobenzene), cis- and trans-stilbene and mixtures of two or more thereof are excluded as compounds of the formula (I);

and by the preparation of a reaction product (A′) which comprises the following stage (i):

(i) Reaction, under free radical conditions, of a reaction mixture comprising at least one monomer (a), capable of free radical reaction, in the presence of at least one compound of the formula (II)

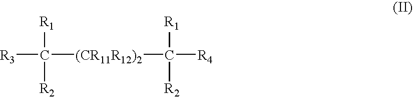

where R₁ to R₄ and R₁₁ and R₁₂, independently of one another, are each hydrogen, methyl or a group which stabilizes radicals and/or is bulky and which is selected from an unsubstituted or substituted, linear or branched alkyl of two or more carbon atoms, a cycloalkyl, alcohol, ether, polyether, amine or aralkyl radical, a substituted or unsubstituted aromatic, heterocyclic or olefinic hydrocarbon, a halogen atom, a substituted or unsubstituted, linear or branched alkenyl or alkynyl group, —C(O)R₅, —C(O)OR₅, —CR₅R₆—O—R₇, —O—C(O)R₅, —CN, —O—CN, —S—CN, —O—C═NR₅, —S—C═NR₅, —O—CR₅R₆—CR₇R₈NR₉R₁₀, —N═C═O, —C═NR₅, —CR₅R₆-Hal, —C(S)R₅, —CR₅R₆—P(O)R₇R₈, —CR₅R₆—PR₇R₈, —CR₅R₆—NR₇R₈, —CR₅R₆(OR₇)(OR₈), —CR₅R₆(OR₇)(NR₈), —CR₅R₆(NR₇)(NR₈), an anhydride, acetal or ketal group, —SO₂R₅, an amidine group, —NR₅C(S)NR₆, —NR₅C(S)—OR₆, —N═C═S, —NO₂, —C═N—OH, —N(R₅)═NR₆, —PR₅R₆R₇, —OSiR₅R₆R₇ or —SiR₅R₆R₇, where R₅ to R₁₀, independently of one another, are each defined in the same way as R₁ to R₄, or two of the radicals R₁ to R₄ form a C₄- to C₇-ring which in turn may be substituted or unsubstituted and may contain one or more heteroatoms,

with the proviso that

at least two of the radicals R₁ to R₄ are a group which stabilizes radicals and/or is bulky, as defined above,

and by a

reaction product (A) which can be prepared by means of a process comprising the following stage (i):

(i) Reaction, under free radical conditions, of a reaction mixture comprising at least one monomer (a), capable of free radical reaction, in the presence of at least one compound of the formula (I)

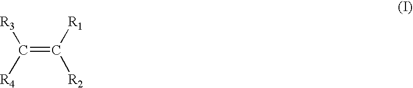

where R₁ to R₄, independently of one another, are each hydrogen, methyl or a group which stabilizes radicals and/or is bulky and which is selected from an unsubstituted or substituted, linear or branched alkyl of two or more carbon atoms, a cycloalkyl, alcohol, ether, polyether, amine or aralkyl radical, a substituted or unsubstituted aromatic, heterocyclic or olefinic hydrocarbon, a halogen atom, a substituted or unsubstituted, linear or branched alkenyl or alkynyl group, —C(O)R₅, —C(O)OR₅, —CR₅R₆—O—R₇, —O—C(O)R₅, —CN, —O—CN, —S—CN, —O—C═NR₅, —S—C═NR₅, —O—CR₅R₆—CR₇R₈NR₉R₁₀, —N═C═O, —C═NR₅, —CR₅R₆-Hal, —C(S)R₅, —CR₅R₆—P(O)R₇R₈, —CR₅R₆—PR₇R₈, —CR₅R₆—NR₇R₈, —CR₅R₆(OR₇)(OR₈), —CR₅R₆(OR₇)(NR₈), —CR₅R₆(NR₇)(NR₈), an anhydride, acetal or ketal group, —SO₂R₅, an amidine group, —NR₅C(S)NR₆, —NR₅C(S)—OR₆, —N═C═S, —NO₂, —C═N—OH, —N(R₅)═NR₆, —PR₅R₆R₇, —OSiR₅R₆R₇ or —SiR₅R₆R₇, where R₅ to R₁₀, independently of one another, are each defined in the same way as R₁ to R₄, or two of the radicals R₁ to R₄ form a C₄- to C₇-ring which in turn may be substituted or unsubstituted and may contain one or more heteroatoms,

with the proviso that

at least two of the radicals R₁ to R₄ are a group which stabilizes radicals and/or is bulky, as defined above, and diphenylethylene, dinaphthylethylene, 4,4′-vinylidenebis(N,N′-dimethylaniline), 4,4′-vinylidenebis(aminobenzene), cis- and trans-stilbene and mixtures of two or more thereof are excluded as compounds of the formula (I), and a

reaction product (A′) which can be prepared by means of a process comprising the following stage (i):

(i) Reaction, under free radical conditions, of a reaction mixture comprising at least one monomer (a), capable of free radical reaction, in the presence of at least one compound of the formula (II)

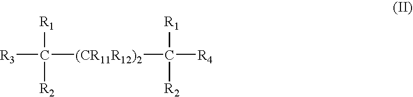

where R₁ to R₄ and R₁₁ and R₁₂, independently of one another, are each hydrogen, methyl or a group which stabilizes radicals and/or is bulky and which is selected from an unsubstituted or substituted, linear or branched alkyl of two or more carbon atoms, a cycloalkyl, alcohol, ether, polyether, amine or aralkyl radical, a substituted or unsubstituted aromatic, heterocyclic or olefinic hydrocarbon, a halogen atom, a substituted or unsubstituted, linear or branched alkenyl or alkynyl group, —C(O)R₅, —C(O)OR₅, —CR₅R₆—O—R₇, —O—C(O)R₅, —CN, —O—CN, —S—CN, —O—C═NR₅, —S—C═NR₅, —O—CR₅R₆—CR₇R₈NR₉R₁₀, —N═C═O, —C═NR₅, —CR₅R₆-Hal, —C(S)R₅, —CR₅R₆—P(O)R₇R₈, —CR₅R₆—PR₇R₈, —CR₅R₆—NR₇R₈, —CR₅R₆(OR₇)(OR₈), —CR₅R₆(OR₇)(NR₈), —CR₅R₆(NR₇)(NR₈), an anhydride, acetal or ketal group, —SO₂R₅, an amidine group, —NR₅C(S)NR₆, —NR₅C(S)—OR₆, —N═C═S, —NO₂, —C═N—OH, —N(R₅)═NR₆, —PR₅R₆R₇, —OSiR₅R₆R₇ or —SiR₅R₆R₇, where R₅ to R₁₀, independently of one another, are each defined in the same way as R₁ to R₄, or two of the radicals R₁ to R₄ form a C₄- to C₇-ring which in turn may be substituted or unsubstituted and may contain one or more heteroatoms,

with the proviso that

at least two of the radicals R₁ to R₄ are a group which stabilizes radicals and/or is bulky, as defined above,

and a process for the preparation of a polymer (B), which comprises:

(ii) Reaction of the reaction product (A) and/or (A′) obtained in stage (i), under free radical conditions, in the presence of at least one monomer (b) capable of free radical homopolymerization or copolymerization,

and polymer B which can be prepared by a process comprising the stage (ii):

(ii) Reaction of the reaction product (A) and/or (A′) obtained in stage (i), under free radical conditions, in the presence of at least one monomer (b) capable of free radical homopolymerization or copolymerization.

All monomers capable of free radical reaction may be used as monomer (a) in the above novel process. Preferably, compounds capable of free radical homopolymerization or copolymerization are used as monomer (a).

Of course, mixtures of different monomers can also be used as monomers (a) in the context of the present invention.

In addition, mixtures of at least one hydrophilic monomer and at least one hydrophobic monomer can be polymerized by the abovementioned process.

Specific examples of monomers (a) are:

dienes, such as butadiene, isoprene, myrcene or pentadiene, and furthermore C₁- to C₂₀-alkyl and hydroxyalkyl esters of monoethylenically unsaturated C₃- to C₁₀-monocarboxylic acids or C₄- to C₈-dicarboxylic acids, for example methyl methacrylate, ethyl methacrylate, propyl methacrylate (all isomers), butyl methacrylate (all isomers), 2-ethylhexyl methacrylate, isobornyl methacrylate, methyl acrylate, ethyl acrylate, propyl acrylate (all isomers), butyl acrylate (all isomers), 2-ethylhexyl acrylate, isobornyl acrylate, benzyl acrylate, phenyl acrylate, stearyl acrylate, diethyl maleate, hydroxyethyl acrylate, hydroxypropyl acrylate or hydroxybutyl acrylate, furthermore (meth)acrylates of alkoxylated C₁- to C₁₈-alcohols which have been reacted with from 2 to 50 mol of ethylene oxide, propylene oxide, butylene oxide or mixtures thereof; benzyl methacrylate, phenyl methacrylate, stearyl methacrylate, methacrylonitrile, acrylonitrile or functionalized methacrylates; acrylates and styrenes, selected from glycidyl methacrylate, 2-hydroxyethyl methacrylate, hydroxypropyl methacrylate (all isomers), hydroxybutyl methacrylate (all isomers), cyclohexyl methacrylate, cyclohexyl acrylate, hexyl methacrylate and hexyl acrylate (in each case all isomers), diethylaminoethyl methacrylate, triethylene glycol methacrylate, itaconic anhydride, itaconic acid, glycidyl acrylate, 2-hydroxyethyl methacrylate, diethylaminoethyl acrylate, triethylene glycol acrylate, methacrylamide, N-tert-butylmethacrylamide, N-n-butylmethacrylamide, N-methylolmethacrylamide, N-ethylolmethacrylamide, N-tert-butylacrylamide, N-butylacrylamide, N-methylolacrylamide, N-ethylolacrylamide, vinylbenzoic acid (all isomers), diethylaminostyrene (all isomers), α-methylvinylbenzenesulfonic acid (all isomers), diethylamino-α-methylstyrene (all isomers), p-methylstyrene, p-vinylbenzenesulfonic acid, trimethoxysilylpropyl methacrylate, triethoxysilylpropyl methacrylate, tributoxysilylpropyl methacrylate, diethoxymethylsilylpropyl methacrylate, dibutoxymethylsilylpropyl methacrylate, diisopropoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, trimethoxysilylpropyl acrylate, triethoxysilypropyl acrylate, tributoxysilylpropyl acrylate, dimethoxymethylsilylpropyl acrylate, diethoxymethylsilylpropyl acrylate, dibutoxymethylsilylpropyl acrylate, diisopropoxymethylsilylpropyl acrylate, dimethoxysilylpropyl acrylate, diethoxysilylpropyl acrylate, dibutoxysilylpropyl acrylate, diisopropoxysilylpropyl acrylate, vinyl acetate and vinyl butyrate, vinyl chloride, vinyl fluoride, vinyl bromide, vinyl alcohol, vinyl ethers of C₁- to C₁₈-alcohols, vinyl ethers of alkoxylated C₁- to C₁₈-alcohols and vinyl ethers of polyalkylene oxides, such as polyethylene oxide, polypropylene oxide or polybutylene oxide, monoethylenically unsaturated C₃- to C₁₀-monocarboxylic acids, their alkali metal salts and/or ammonium salts, for example acrylic acid or methacrylic acid, dimethylacrylic acid, ethylacrylic acid, allylacetic acid or vinylacetic acid, furthermore monoethylenically unsaturated C₄- to C₈-dicarboxylic acids, their monoesters, anhydrides, alkali metal salts and/or ammonium salts, for example maleic acid, fumaric acid, itaconic acid, mesaconic acid, methylenemalonic acid, citraconic acid, maleic anhydride, itaconic anhydride or methylmalonic anhydride; furthermore monoethylenically unsaturated monomers containing sulfo groups or their salts, for example their alkali metal salts or ammonium salts, for example allylsulfonic acid, styrenesulfonic acid, 2-acrylamido-2-methylpropanesulfonic acid (AMPS), methallylsulfonic acid, vinylsulfonic acid, 3-sulfopropyl acrylate or 3-sulfopropyl methacrylate, furthermore monoethylenically unsaturated monomers containing phosphonic acid groups or their salts, for example their alkali metal salts or ammonium salts, for example vinylphosphonic acid, allylphosphonic acid or acrylamidoethylpropanephosphonic acid, furthermore amides and N-substituted amides of monoethylenically unsaturated C₃- to C₁₀-monocarboxylic acids or C₄- to C₈-dicarboxylic acids, for example acrylamide, N-alkylacrylamides or N,N-dialkylacrylamides, each having 1 to 18 carbon atoms in the alkyl group, such as N-methylacrylamide, N,N-dimethylacrylamide, N-tert-butylacrylamide or N-octadecylacrylamide, N-monomethylhexylmaleamide, N-monodecylmaleamide, diethylaminopropylmethacrylamide or acrylamidoglycollic acid; furthermore alkylaminoalkyl (meth)acrylates, for example dimethylaminoethyl acrylate, dimethylaminoethyl methacrylate, ethylaminoethyl acrylate, diethylaminoethyl methacrylate, dimethylaminopropyl acrylate or dimethylaminopropyl methacrylate; furthermore vinyl esters, such as vinyl formate, vinyl acetate or vinyl propionate, it also being possible for these to be present in hydrolyzed form after the polymerization; furthermore N-vinyl compounds, for example N-vinylpyrrolidone, N-vinylcaprolactam, N-vinylformamide, N-vinyl-N-methylformamide, 1-vinylimidazole or 1-vinyl-2-methylimidazole; furthermore vinyl ethers of C₁- to C₁₈-alcohols, vinyl ethers of alkoxylated C₁- to C₁₈-alcohols and vinyl ethers of polyalkylene oxides, such as polyethylene oxide, polypropylene oxide or polybutylene oxide, styrene or its derivatives, such as α-methylstyrene, indene, dicyclopentadiene, monomers which carry amino or imino groups, such as dimethylaminoethyl methacrylate, diethylaminoethyl acrylate, diethylaminopropylmethacrylamide or allylamine, monomers which carry quaternary ammonium groups, for example present as salts as obtained by reacting the basic amino functions with acids, such as hydrochloric acid, sulfuric acid, nitric acid, formic acid or acetic acid, or in quaternized form (examples of suitable quaternizing agents are dimethyl sulfate, diethyl sulfate, methyl chloride, ethyl chloride or benzyl chloride), e.g. dimethylaminoethyl acrylate hydrochloride, diallyldimethylammonium chloride, dimethylaminoethyl acrylate methylchloride, dimethylaminoethylaminopropylmethacrylamide methosulfate, vinylpyridinium salts or 1-vinylimidazolium salts; monomers in which the amino groups and/or ammonium groups are liberated only after polymerization and subsequent hydrolysis, for example N-vinylformamide or N-vinylacetamide, and mixtures of two or more of the abovementioned monomers.

Preferably used as a first monomer (a) are styrenes, acrylonitrile, (meth)acrylates or their free acid, dienes or N-vinyl compounds, preferably those members of this group which have already been mentioned above, or mixtures of two or more, if required with at least one further monomer (a) capable of free radical homopolymerization or copolymerization.

According to the invention, a compound of the formula (I)

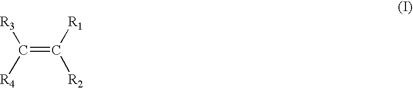

or of the formula (II)

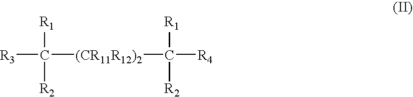

is further being used in the preparation of the reaction product (A).

In principle, it is also possible here to use all the compounds of the abovementioned formulae according to the invention, as long as they correspond to the definition given above and in the claims.

It is particularly important that at least two of the radicals R₁ to R₄ are each a radical-stabilizing and/or bulky group. The term “bulky group” as used in the context of the present invention means that this is a group whose size in each case in the novel reaction under free radical conditions is larger than or equal to the size of an isopropyl radical. The term “radical-stabilizing group” used according to the invention refers to groups of the type defined in claim 1, whose electron structure permits stabilization of radicals.

Specific examples are the following groups of the abovementioned type:

branched alkyl groups having three or more carbon atoms, in particular isopropyl and tert-butyl; cycloalkyl groups, for example unsubstituted or substituted cyclopentyl or cyclohexyl; alcohol groups, for example radicals of branched alcohols, such as isopropoxy or tert-butoxy; aralkyl radicals; substituted or unsubstituted aromatic or heterocyclic hydrocarbons, for example phenyl or pyridyl; halogen; cyano; nitro; ester groups having the structure —CO(O)OR₅, such as linear or branched, unsubstituted or substituted alkyl or aralkyl, aromatic or heteroaromatic compounds.

Also preferably used are compounds of the formula (I) which have stabilizing groups of the following combinations as radicals:

at least one substituted or unsubstituted phenyl and C(O)R₅;

at least one substituted or unsubstituted phenyl and CN;

at least one substituted or unsubstituted phenyl and C(O)OR₅;

independently of one another, at least two substituted or unsubstituted phenyl groups;

independently of one another, at least two C(O)OR₅; and

independently of one another, at least two CN.

In particular, the following are used as compound of the formula (I) or (II):

1,1,4,4-tetraphenyl-1,3-butadiene

1,4-bis(2-methylstyryl)benzene

1,2,3,4,5-pentaphenyl-1,3-cyclopentadiene

1,2,3,4-tetraphenyl-1,3-cyclopentadiene

acenaphthylene

cis- and trans-alpha-methylstilbene

cis- and trans-4,4′-diphenylstilbene

trans-trans- and trans-cis- and cis-cis-1,4-diphenyl-1,3-butadiene

alpha-omega-tetraphenylpolyethyne

diphenylfulvene

triphenylethene

tetraphenylethene

1-cyano-1-phenylethylene; 1-alkoxycarbonyl-1-phenylethylene; 1,1-dialkoxycarbonyl-2-ethylethylene; 1,1-dialkoxycarbonyl-2-phenylethylene, 1,1-dialkoxycarbonyl-2,2-dimethylethylene; 1,1-dialkoxycarbonylmethylethylene; 9-methylenexanthene; 9-methylenethioxanthene, 9-methylene-10-H-acridine and mixtures of two or more thereof.

According to the invention, the free radical formation can be effected by various methods. Thus, thermal, photochemical, electrochemical or electron transfer-induced production is just as possible as the use of oxidizing or reducing agents for producing free radicals.

In addition, the novel process can be carried out in the presence of at least one free radical initiator. Furthermore, thermally, electrochemically or photochemically initiating monomers can also be used as initiators. In general, however, all azo and/or peroxo compounds and/or compounds having homolytically cleavable C—C bonds which are conventionally used in free radical chain polymerization may be employed. Suitable initiators are described on page 10, line 17 to page 11, line 15 of WO 98/01478, which is hereby fully incorporated by reference in the context of the present application; moreover, 3,4-dimethyl-3,4-diphenylhexane and 2,3-dimethyl-2,3-diphenylbutane can be used. Preferably used initiators are those which are soluble in the reaction system used in each case. In the case of a reaction in the aqueous phase, oxidizing free radical initiators, e.g. potassium peroxodisulfate, sodium peroxodisulfate and ammonium peroxodisulfate, or a combination of a conventional, i.e. nonoxidizing, initiator with H₂O₂ are preferably used. Furthermore, dicumyl peroxide, dibenzoyl peroxide, dilauryl peroxide and AIBN may be used.

In a preferred embodiment of the novel process, a comparatively large amount of free radical initiator is added, the proportion of free radical initiator in the reaction mixture preferably being from 1 to 50, particularly preferably from 5 to 20% by weight, based in each case on the total amount of the monomer (a) and of the initiator. Preferably, the molar ratio of initiator to compound (I) is from 3:1 to 1:3, particularly preferably from 2:1 to 1:2, in particular from 1.5:1 to 1:1.5.

If the described reaction according to stage (i) is carried out in the aqueous phase, the term “aqueous phase” in the context of the present invention is understood as meaning a phase which contains from 10 to 100% by weight of water. If the water content of the aqueous phase is less than 10%, it is preferable in the context of the present invention if the aqueous phase contains a mixture of water and one or more water-miscible solvents, such as THF, methanol, ethanol, propanol, butanol, acetone, methyl ethyl ketone or the like. However, it is also possible to carry out the reaction according to stage (i) in the presence of a mixture of water and a water-immiscible solvent, such as an aromatic solvent, for example toluene.

In a further embodiment, the above reaction according to stage (i) is carried out in the presence of at least one base. It is possible in principle to use all low molecular weight bases, of which NaOH, KOH, ammonia, diethanolamine, triethanolamine, mono-, di- or triethylamine, dimethylethanolamine or a mixture of two or more thereof are preferred and ammonia and di- and triethanolamine are particularly preferred.

However, it is also possible to carry out the reaction according to stage (i) in an organic solvent or in the absence of a solvent, for example in the melt. When the term “reaction procedure in an organic solvent or in the absence of a solvent” is used in the context of the present invention, it is understood as meaning a reaction procedure which takes place in the presence of less than 10, preferably less than 5 or less than 1% by weight of water. In a further embodiment of the present invention, at least one block copolymer is used in the novel binder composition, in the preparation of which block copolymer stage (i) was carried out in an organic solvent or in the absence of a solvent, the water content of the reaction mixture being less than 0.5, for example less than 0.3 or less than 0.1% by weight. In a further embodiment of the present invention, the reaction procedure of stage (i) is carried out in the absence of water, i.e. with a water content of less than 0.001% by weight. Such water contents can be achieved, for example, by using commercially available solvents as usually used as organic solvents in free radical polymerizations.

Suitable solvents in the context of the present invention are in principle all polar and nonpolar organic solvents in which the corresponding and preferably also the resulting polymers are soluble, possibly at elevated temperatures. Suitable solvents are, for example, C₃- to C₁₀-alkanes, cyclohexane, decalin, acetone, methyl ethyl ketone, diisobutyl ketone, tetrahydrofuran, dioxane, benzene, toluene, glycols, such as ethylene glycol or triethylene glycol, glycol ethers in which some or all of the terminal groups are blocked, such as ethylene glycol monomethyl ether, ethyl acetate, methanol or ethanol or the higher homologs of the alkanols of up to 18 carbon atoms (if necessary as cosolvent) or mixtures of two or more thereof.

The reaction according to stage (i) is carried out in general at above room temperature and below the decomposition temperature of the monomers, the temperature range from 50 to 200° C. preferably being chosen, particularly preferably from 70 to 150° C., in particular from 80 to 120° C.

The reaction according to stage (i) is carried out in general at from 1 to 300, for example from about 1.5 to 100 or from about 2 to about 20 bar.

Although there are no restrictions at all with respect to the molecular weight distribution, a reaction product which has a molecular weight distribution M_{w}/Mₙ, measured by gel permeation chromatography using polystyrene as standard, of ≦4, preferably ≦3, particularly preferably ≦2, in particular ≦1.5 and in specific cases even ≦1.3 can be obtained in the reaction according to (i). The molecular weights of the reaction product (A) can be controlled within wide limits by the choice of the ratio of monomers (a) to compounds (I) to free radical initiator. In particular, the content of compound (I) determines the molecular weight and does so in such a way that the greater the amount of compound (I), the lower the resulting molecular weight.

The reaction according to stage (i) can also be carried out in the presence of a surfactant.

The reaction product obtained in the reaction according to (i) can be further processed directly or used as a macroinitiator for the further reaction according to stage (ii), as defined further below herein. It is also possible to isolate the reaction product according to stage (i) as a solid and then to subject it to further reaction or to use it.

In the reaction according to stage (ii), at least one freely selectable monomer (b) capable of free radical homopolymerization or copolymerization can be reacted, suitable monomers (b) being the monomers stated above in the description of the monomers (a).

Monomer (b) may be identical to or different from the monomer (a) used in stage (i). Of course, mixtures of two or more monomers may also be used as monomer (a) or monomer (b). The choice of the monomer (b) is made in principle according to the desired structure of the polymer prepared in stage (ii) and hence according to the desired use of this polymer.

Specific examples are the following monomers (b) to be used with preference: Styrene and derivatives, e.g. styrenesulfonic acid, methacrylic acid and acrylic acid, and the esters of the acids with methanol, ethanol, propanol (all isomers) or butanol (all isomers), hexane (all isomers), vinyl acetate, hydroxyethyl acrylate, hydroxyethyl methacrylate, N-vinyl compounds, e.g. N-vinylpyrrolidone, and dienes, such as butadiene, isoprene, myrcene and pentadiene.

Accordingly, the present invention also relates to a process for the preparation of a polymer (B), which comprises:

(ii) Reaction of the reaction product (A) obtained in stage (i), under free radical conditions, in the presence of at least one monomer (b) capable of free radical homopolymerization or copolymerization.

The reaction according to stage (ii) is carried out in principle under the conventional conditions for a free radical polymerization, it being possible for suitable solvents to be present.

In a further embodiment of the present invention, stage (ii) can be carried out in the presence of compounds of the general formula I or II, which are added after the end of stage (i).

In the context of the novel process, stages (i) and (ii) can be carried out separately from one another in terms of both space and time, in which case of course stage (i) is carried out first, followed by stage (ii). In addition, stages (i) and (ii) can also be carried out in one reactor in succession, i.e. first the compound of the formula (I) is reacted with at least one monomer (a) completely or partly depending on the desired use or the desired properties, then at least one monomer (b) is added and is subjected to free radical polymerization, or a monomer mixture comprising at least one monomer (a) and at least one monomer (b) is used from the outset and is reacted with the compound (I). It is assumed that the compound (I) first reacts with the at least one monomer (a) and the reaction product (A) formed therefrom then also reacts with the monomer (b) above a specific molecular weight. In this respect, it should be noted in particular that the novel (co)polymerization can also be continued after any interruption without further initiator addition, by heating to a temperature at which the macroinitiator formed according to reaction product (A) decomposes again.

The resulting polymer (reaction product (A)) can be isolated or can be heated again in situ to initiate the (further) polymerization. Further monomer (b) can be added directly. Monomer (b) can be identical to or different from monomer (a). Furthermore, monomer mixtures may be used from the outset. Step (ii) can be repeated as often as desired, if necessary after isolation of the products formed in the individual stages.

Depending on the reaction procedure, it is possible according to the invention to prepare polymers functionalized on the terminal groups, segmented polymers, block or multiblock and gradient (co)polymers, star (co)polymers, graft copolymers and branched and hyperbranched (co)polymers.

As is evident from the above, the present invention also relates to the polymer (B) per se which can be prepared by the process defined above. The novel reaction is preferably carried out in such a way that a polymer (B) which has a block structure is obtained. It is possible according to the invention, in a simple manner using an easily obtainable compound (I), to provide block copolymers which have, for example, a hydrophilic block, such as a (meth)acrylic acid or a C₁₋₄-alkyl (meth)acrylate block, and a further, preferably hydrophobic polymer block, such as a block based on vinylaromatic monomers, e.g. styrene or substituted styrenes, acrylonitrile, dienes and nonaromatic vinyl compounds, such as vinyl acetate, and higher (>C₄) alkyl (meth)acrylates.

According to the invention, polymers of the following structure can also be prepared:

poly((meth)acrylic acid-stat-(meth)acrylate-b-(styrene-stat-(meth)acrylate)), where the term “(meth)acrylate” denotes alkyl esters of methacrylic acid and acrylic acid.

Specific examples are the following block copolymers:

Poly(acrylic acid-b-styrene), poly(methyl methacrylate-b-styrene), poly(styrene-b-vinyl acetate), poly(methacrylic acid-b-hydroxyethyl acrylate), poly(methyl methacrylate-b-N-vinylpyrrolidone), poly(methyl methacrylate-b-N-vinylformamide), poly(methyl methacrylate-b-hydroxyethyl acrylate), poly(methyl methacrylate-b-(styrene-stat-acrylonitrile)), poly(n-butyl acrylate-b-styrene-b-n-butyl acrylate), poly(methyl methacrylate-b-styrene-b-methyl methacrylate-b-styrene) and poly(n-butyl acrylate-b-styrene-b-n-butyl acrylate-b-styrene).

Furthermore, it is possible to prepare, for example, polymers of the following structure which can be used in the novel binder compositions:

Poly((meth)acrylic acid-stat-(meth)acrylate-b-(styrene-stat-(meth)acrylate)), where the term “(meth)acrylate” denotes alkyl esters of methacrylic acid and acrylic acid.

Specific examples are the following block copolymers:

Poly(styrene-b-acrylic acid), poly(styrene-b-methyl acrylate), poly(styrene-b-ethyl acrylate), poly(styrene-b-methacrylic acid), poly(styrene-b-methyl methacrylate), poly(styrene-b-ethyl methacrylate), poly(hydroxyethyl acrylate-b-methacrylic acid), poly(N-vinylpyrrolidone-b-methyl acrylate), poly(N-vinylpyrrolidone-b-ethyl acrylate), poly(N-vinylpyrrolidone-b-methyl methacrylate), poly(N-vinylpyrrolidone-b-ethyl methacrylate), poly(N-vinylpyrrolidone-b-styrene), poly(N-vinylpyrrolidone-b-vinyl acetate), poly(N-vinylpyrrolidone-b-α-methylstyrene), poly(N-vinylformamide-b-methyl methacrylate), poly(N-vinyl-formamide-b-ethyl methacrylate), poly(N-vinylformamide-b-vinyl acetate), poly(N-vinylformamide-b-methyl acrylate) and poly(N-vinylformamide-b-ethyl acrylate).

The following can also be prepared according to the present invention:

Poly(methyl methacrylate-b-(styrene-stat-acrylonitrile)), poly(n-butyl acrylate-b-styrene-b-n-butyl acrylate), poly(styrene-b-n-butyl acrylate-b-styrene), poly(styrene-b-n-butyl acrylate-b-styrene-b-n-butyl acrylate), poly(methyl methacrylate-b-styrene-b-methyl methacrylate-b-styrene), poly(n-butyl acrylate-b-styrene-b-n-butyl acrylate-b-styrene), poly(styrene-b-polybutadiene), poly(styrene-b-styrene-stat-butadiene), poly(styrene-stat-acrylonitrile-b-butadiene), poly-(styrene-stat-acrylonitrile-b-styrene-stat-butadiene), poly(styrene-stat-acrylonitrile-b-styrene-stat-acrylonitrile-stat-butadiene), poly(styrene-b-vinylpyrrolidone), poly(styrene-stat-acrylonitrile-vinylpyrrolidone), poly(n-butyl acrylate-b-styrene), poly(n-butyl acrylate-styrene-acrylonitrile), and their ABA and ABC three-block or higher block copolymers and the like.

The present invention furthermore relates to a mixture comprising the novel reaction product (A) or (A′), the novel polymer (B) or a combination of two or more thereof and films, moldings, fibers or foams produced therefrom.

In particular, an aqueous mixture which contains the reaction product (A) or (A′) can be used as a primary dispersion. The reaction product (A) or (A′) or the polymer (B) or a mixture of two or more thereof can be used according to the field of use, in the form suitable therefor, in particular in polymer dispersions.

We claim:

1. A process for the preparation of a reaction product (A), which comprises the following stage (i):
(i) Reaction, under free radical conditions, of a reaction mixture comprising at least one monomer (a), capable of free radical reaction, in the presence of at least one compound of the formula (I) 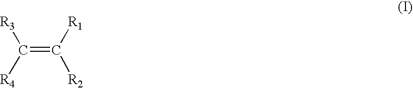
where R₁ to R₄, independently of one another, are each hydrogen, methyl or a group which stabilizes radicals and/or is bulky and which is selected from an unsubstituted or substituted, linear or branched alkyl of two or more carbon atoms, a cycloalkyl, alcohol, ether, polyether, amine or aralkyl radical, a substituted or unsubstituted aromatic, heterocyclic or olefinic hydrocarbon, a halogen atom, a substituted or unsubstituted, linear or branched alkenyl or alkynyl group, —C(O)R₅, —C(O)OR₅, —CR₅R₆—O—R₇, —O—C(O)R₅, —CN, —O—CN, —S—CN, —O—C═NR₅, —S—C═NR₅, —O—CR₅R₆—CR₇R₈NR₉R₁₀, —N═C═O, —C═NR₅, —CR₅R₆-Hal, —C(S)R₅, —CR₅R₆—P(O)R₇R₈, —CR₅R₆—PR₇R₈, —CR₅R₆—NR₇R₈, —CR₅R₆(OR₇)(OR₈), —CR₅R₆(OR₇)(NR₈), —CR₅R₆(NR₇)(NR₈), an anhydride, acetal or ketal group, —SO₂R₅, an amidine group, —NR₅C(S)NR₆, —NR₅C(S)—OR₆, —N═C═S, —NO₂, —C═N—OH, —N(R₅)═NR₆, —PR₅R₆R₇, —OSiR₅R₆R₇ or —SiR₅R₆R₇, where R₅ to R₁₀, independently of one another, are each defined in the same way as R₁ to R₄, or two of the radicals R₁ to R₄ form a C₄- to C₇-ring which in turn may be substituted or unsubstituted and may contain one or more heteroatoms,
with the proviso that
at least two of the radicals R₁ to R₄ are a group which stabilizes radicals and/or is bulky, as defined above, and diphenylethylene, dinaphthylethylene, 4,4′-vinylidenebis(N,N′-dimethylaniline), 4,4′-vinylidenebis(aminobenzene), cis- and trans-stilbene and mixtures of two or more thereof are excluded as compounds of the formula (i).

2. A process for the preparation of a reaction product (A′), which comprises the following stage (i):
(i) Reaction, under free radical conditions, of a reaction mixture comprising at least one monomer (a), capable of free radical reaction, in the presence of at least one compound of the formula (II) 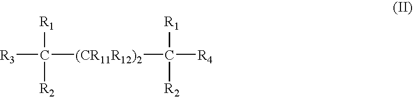
where R₁ to R₄ and R₁₁ and R₁₂, independently of one another, are each hydrogen, methyl or a group which stabilizes radicals and/or is bulky and which is selected from an unsubstituted or substituted, linear or branched alkyl of two or more carbon atoms, a cycloalkyl, alcohol, ether, polyether, amine or aralkyl radical, a substituted or unsubstituted aromatic, heterocyclic or olefinic hydrocarbon, a halogen atom, a substituted or unsubstituted, linear or branched alkenyl or alkynyl group, —C(O)R₅, —C(O)OR₅, —CR₅R₆—O—R₇, —O—C(O)R₅, —CN, —O—CN, —S—CN, —O—C═NR₅, —S—C═NR₅, —O—CR₅R₆—CR₇R₈NR₉R₁₀, —N═C═O, —C═NR₅, —CR₅R₆-Hal, —C(S)R₅, —CR₅R₆—P(O)R₇R₈, —CR₅R₆—PR₇R₈, —CR₅R₆—NR₇R₈, —CR₅R₆(OR₇)(OR₈), —CR₅R₆(OR₇)(NR₈), —CR₅R₆(NR₇)(NR₈), an anhydride, acetal or ketal group, —SO₂R₅, an amidine group, —NR₅C(S)NR₆, —NR₅C(S)—OR₆, —N═C═S, —NO₂, —C═N—OH, —N(R₅)═NR₆, —PR₅R₆R₇, —OSiR₅R₆R₇ or —SiR₅R₆R₇, where R₅ to R₁₀, independently of one another, are each defined in the same way as R₁ to R₄, or two of the radicals R₁ to R₄ form a C₄- to C₇-ring which in turn may be substituted or unsubstituted and may contain one or more heteroatoms,
with the proviso that
at least two of the radicals R₁ to R₄ are a group which stabilizes radicals and/or is bulky, as defined above.

3. A process as claimed in either of claims 1 and 2, the reaction being carried out in the presence of at least one base.
formula (I) or (II) having the following combinations as groups which stabilize radicals and/or are bulky:
at least one substituted or unsubstituted phenyl and —C(O)R₅;
at least one substituted or unsubstituted phenyl and —CN;
at least one substituted or unsubstituted phenyl and —C(O)OR₅;
independently of one another, at least two substituted or unsubstituted phenyl groups;
independently of one another, at least two —C(O)OR₅; and
independently of one another, at least two —CN.

5. A process as claimed in any of claims 1 to 4, the compound of the formula (I) or (II) being selected from:
1,1,4,4-tetraphenyl-1,3-butadiene
1,4-bis(2-methylstyryl)benzene
1,2,3,4,5-pentaphenyl-1,3-cyclopentadiene
1,2,3,4-tetraphenyl-1,3-cyclopentadiene
acenaphthylene
cis- and trans-alpha-methylstilbene
cis- and trans-4,4′-diphenylstilbene
trans-trans- and trans-cis- and cis-cis-1,4-diphenyl-1,3-butadiene
alpha-omega-tetraphenylpolyethyne
diphenylfulvene
triphenylethene
tetraphenylethene
1-cyano-1-phenylethylene; 1-alkoxycarbonyl-1-phenylethylene; 1,1-dialkoxycarbonyl-2-ethylethylene; 1,1-dialkoxycarbonyl-2-phenylethylene, 1,1-dialkoxycarbonyl-2,2-dimethylethylene; 1,1-dialkoxycarbonylmethylethylene; 9-methylenexanthene; 9-methylenethioxanthene, 9-methylene-10-H-acridine, 1,4-dialkoxy-1,1,4,4-tetraphenylbutane, 1,4-dialkoxycarbonyl-1,1,4,4-tetraphenylbutane, 1,4-dicyano-1,1,4,4-tetraphenylbutane, 1,4-(trialkylsilyloxy)-1,1,4,4-tetraphenylbutane and mixtures of two or more thereof.

6. A process as claimed in any of claims 1 to 5, the low molecular weight base being NaOH, KOH, ammonia, diethanolamine, triethanolamine, mono-, di- or triethylamine, dimethylethanolamine or a mixture of two or more thereof.

7. A reaction product (A) which can be prepared by means of a process comprising the following stage (i):
(i) Reaction, under free radical conditions, of a reaction mixture comprising at least one monomer (a) capable of free radical reaction, in the presence of at least one compound of the formula (I) 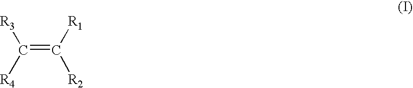
where R₁ to R₄, independently of one another, are each hydrogen, methyl or a group which stabilizes radicals and/or is bulky and which is selected from an unsubstituted or substituted, linear or branched alkyl of two or more carbon atoms, a cycloalkyl, alcohol, ether, polyether, amine or aralkyl radical, a substituted or unsubstituted aromatic, heterocyclic or olefinic hydrocarbon, a halogen atom, a substituted or unsubstituted, linear or branched alkenyl or alkynyl group, —C(O)R₅, —C(O)OR₅, —CR₅R₆—O—R₇, —O—C(O)R₅, —CN, —O—CN, —S—CN, —O—C═NR₅, —S—C═NR₅, —O—CR₅R₆—CR₇R₈NR₉R₁₀, —N═C═O, —C═NR₅, —CR₅R₆-Hal, —C(S)R₅, —CR₅R₆—P(O)R₇R₈, —CR₅R₆—PR₇R₈, —CR₅R₆—NR₇R₈, —CR₅R₆(OR₇)(OR₈), —CR₅R₆(OR₇)(NR₈), —CR₅R₆(NR₇)(NR₈), an anhydride, acetal or ketal group, —SO₂R₅, an amidine group, —NR₅C(S)NR₆, —NR₅C(S)—OR₆, —N═C═S, —NO₂, —C═N—OH, —N(R₅)═NR₆, —PR₅R₆R₇, —OSiR₅R₆R₇ or —SiR₅R₆R₇, where R₅ to R₁₀, independently of one another, are each defined in the same way as R₁ to R₄, or two of the radicals R₁ to R₄ form a C₄- to C₇-ring which in turn may be substituted or unsubstituted and may contain one or more heteroatoms,
with the proviso that
at least two of the radicals R₁ to R₄ are a group which stabilizes radicals and/or is bulky, as defined above, and diphenylethylene, dinaphthylethylene, 4,4′-vinylidenebis(N,N′-dimethylaniline), 4,4′-vinylidenebis(aminobenzene), cis- and trans-stilbene and mixtures of two or more thereof are excluded as compounds of the formula (I).

8. A reaction product (A′) which can be prepared by means of a process comprising the following stage (i):
(i) Reaction, under free radical conditions, of a reaction mixture comprising at least one monomer (a), capable of free radical reaction, in the presence of at least one compound of the formula (II) 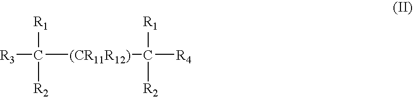
where R₁ to R₄ and R₁₁ and R₁₂, independently of one another, are each hydrogen, methyl or a group which stabilizes radicals and/or is bulky, and is selected from an unsubstituted or substituted, linear or branched alkyl of two or more carbon atoms, a cycloalkyl, alcohol, ether, polyether, amine or aralkyl radical, a substituted or unsubstituted aromatic, heterocyclic or olefinic hydrocarbon, a halogen atom, a substituted or unsubstituted, linear or branched alkenyl or alkynyl group, —C(O)R₅, —C(O)OR₅, —CR₅R₆—O—R₇, —O—C(O)R₅, —CN, —O—CN, —S—CN, —O—C═NR₅, —S—C═NR₅, —O—CR₅R₆—CR₇R₈NR₉R₁₀, —N═C═O, —C═NR₅, —CR₅R₆-Hal, —C(S)R₅, —CR₅R₆—P(O)R₇R₈, —CR₅R₆—PR₇R₈, —CR₅R₆—NR₇R₈, —CR₅R₆(OR₇)(OR₈), —CR₅R₆(OR₇)(NR₈), —CR₅R₆(NR₇)(NR₈), an anhydride, acetal or ketal group, —SO₂R₅, an amidine group, —NR₅C(S)NR₆, —NR₅C(S)—OR₆, —N═C═S, —NO₂, —C═N—OH, —N(R₅)═NR₆, —PR₅R₆R₇, —OSiR₅R₆R₇ or —SiR₅R₆R₇, where R₅ to R₁₀, independently of one another, are each defined in the same way as R₁ to R₄, or two of the radicals R₁ to R₄ form a C₄- to C₇-ring which in turn may be substituted or unsubstituted and may contain one or more heteroatoms,
with the proviso that
at least two of the radicals R₁ to R₄ are a group which stabilizes radicals and/or is bulky, as defined above.

9. A process for the preparation of a polymer (B), which comprises:
(ii) Reaction of the reaction product (A) and/or (A′) obtained in stage (i), under free radical conditions, in the presence of at least one monomer (b) capable of free radical homopolymerization or copolymerization.

10. A polymer B which can be prepared by a process comprising the stage (ii):
(ii) Reaction of the reaction product (A) and/or (A′) obtained in stage (i), under free radical conditions, in the presence of at least one monomer (b) capable of free radical homopolymerization or copolymerization.

11. A mixture comprising a reaction product (A) or (A′) as claimed in either of claims 7 and 8 or a polymer (B) as claimed in claim 10 or a combination of two or more thereof.

12. The use of a mixture containing the reaction product (A) or (A′) or the polymer B or a combination of two or more thereof as a dispersion or for the production of films, moldings, fibers or foams.
